(19) United States
(12) Patent Application Publication
(10) Pub. No.: US 2006/0160053 A1
(43) Pub. Date: Jul. 20, 2006

(54) Psychological development system

(76) Inventor: Mary T. Swenson, Ham Lake, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/336,194

(22) Filed: Jan. 20, 2006

Related U.S. Application Data
(60) Provisional application No. 60/645,433, filed on Jan. 20, 2005.

(51) Int. Cl. G09B 19/00

(52) U.S. Cl. 434/236

(57) ABSTRACT

A psychological development system for assisting in leadership development. The system utilizes triangulation to qualitative theory, quantitative practice and quasitative research. The system evaluates three things (items) three ways, (methods) three levels (subjective, objective and collective) and that this operation can be done separately or three times.

### FIELD OF THE INVENTION

The invention relates generally to a psychological development system. More particularly, the invention relates to a method of encouraging the development of leaders.

### BACKGROUND OF THE INVENTION

To achieve and maintain a maximum quality of life, individuals must utilize their intellect, emotions and will in a holistic approach. This requires personal flexibility and the adaptation of belief systems for alteration and growth to occur. The core concept of an adaptive theory is to facilitate the evolution of conscious changes. Changes are often difficult to make and tend to increase stress. The avoidance of ones problems however, results in greater pain and the immobilization of the self. When an individual or group has exhausted their resources or coping skills, they are most open and willing to look at alternative solutions. It is during a crisis point that seeking alternatives occurs after numerous attempts at maladaptive coping strategies.

The role of a coach, educator, therapist, or consultant is to reeducate and facilitate options for a planning strategy to an improved, balanced functioning. Performance enhancement is realized as a healthy organization or a quality family life. However, the individual or group must recognize the value of a specific process for any intervention to be effective. The onus of change throughout a process is dependent upon interrelationships and motivational drivers. Perception and attitudes vital to development necessitate a willingness to delay gratification, explore alternative avenues, and tolerate discomfort allowing the space and time required for the creation of significant insights and interpretations.

The ultimate outcome is a deeper understanding and increase in competency and finding success despite obstacles and disappointments. Writing a destiny and finding a victory between the poles of violence and victimization two outcomes so often the final result from frustration and the obstruction of directed aims.

The past is used as the foundational template for change joined with the present offering the opportunity to impact the future. The future is the neutral/null hypothesis that can be created flowing from existent thinking, feeling and actions. The role of an objective facilitator or re-creation coach is as a collaborator in reeducation and through the use of specific tools as part of an algorithm together designs an improved method of responding.

Life circumstances can be managed by a combination of interventions, reflection and assessment revealing subtle beliefs, expectations and values. Engaging in a cipher process to illuminate hidden aspects of the personality or a collective occurs over time because there is a “rightness” that will yield positive outcomes. The contribution of a consultant is their trained and educative viewpoint offering instruments by which to expand perspective. Interpretive research fosters imagination, insight, and intuition.

The Relationship

Only in a trusting and respectful environment can individuals examine their issues and concerns. It is important to offer elemental alternatives with varying complexity to determine suitability and appropriateness. This approach considers human beings as good while instinctively striving for growth, belonging and satisfaction. These factors temper each other as an internal check and balance system resulting in an organized decision making process that is unconscious as well as overt (such as using personal takeaways or corporate sweeps). Because people are dynamic and changing entities goals are mutable and subject to revision. It is advantageous in every respect to accentuate abilities while avoiding the overuse of a skill. Further, the management of liabilities must be done.

The model is strength based and seeks to enhance competencies that will benefit the self, others and society. The purpose of life is considered to achieve individuation as well as unity with the greater collective. The model assumes adaptability to adverse circumstances dependent upon navigational skill acquired. Any conditioned learning can be reconditioned and altered to adapt to any eventuality. Both aspects of the executive functioning to relative brain hemisphere results in a higher integration that connects diverse material together resulting in innovation. Uncommon conclusions can be obtained from the ordinary experience.

All humans share a universal condition in the world, each with unique potential. Humans are distinguishable by their capacity to learn through abstraction and cognition and at their best, are careful thinkers. To accomplish a goal of any import individuals have to delay immediate gratification for the long-term outcome. Current society wants it yesterday-but worthwhile achievements take time. Circumstantial factors are inherent to the process and are necessary for full personality development. There is solid evidence that certain characteristics and sound decision-making abilities enable better outcomes.

The interaction of genetics and environmental considerations combine with the mystery of existence manifest through intuition, creativity and logic. The alteration of these elements impacts each of the others. Individuals are a composite of genetic depositions or inherent traits, while environment factors interact with their cultural and historical contexts resulting in depth, meaning and variation.

The physiological (survival) and psychological (belonging) needs must be met before recreational (pleasure) pursuits. While all these drives must be accomplished to function, it is often necessary to subvert an aspect yet, creativity and adaptation also serve as a foundation. This is a third element by which to address basic challenges are often the motivating factor. It is difficult for example, to perform impaired, or incapacitated in some way.

Consider the competent employee who is dissatisfied with their position—a mental state that can interfere with every aspect of their job, home, children, or family. When skill acquisition can be relegated a secondary role and goals are balanced, then an individual is free to experiment and try new things. The procrastination cycle that can take control of inner and external environments must be avoided, which can then can be used to obtain insight. To create implicit structures that use adversity to leverage a situation toward success results in empowerment.

Individuals from impaired family systems seem to either perpetuate dysfunction or they transcend their experiences by overcompensating for the flawed system around them. Significant relationships, perceptions, belief systems and existential conditions impact goals and expectations that can be modulated to a set of unifying principles. Depending upon their characteristics and intrinsic temperament, some individuals can be more resilient than others. The ability to create a present circumstance for change and the drive and required focus is interdependent upon various internal and external drivers.

Social exchanges are dependent upon the support and the adaptability of how an individual or group can view and react to a reality. Reality is of course relative and situational but only to a degree. The challenge of the 21st century may well be to discern what is real and what is artificial and to chose correctly between them. There are limited truths, but they are the cornerstones of wisdom. The importance and meaning assigned by the individual for the purpose of understanding their existence is critical and relevant.

In this construct, factors affecting personality formation display several modes of potential reconstruction and configuration. Each of the areas in the following depiction illustrates a dynamic integrated system between extremes or opposing forces crucial to development. Each area must be considered separately and as an integrated system for well being. One group cannot exist without the other and each has a role in generating how the world is interpreted and what actions result. If a person alters how they think and feel, behavioral change will occur despite environmental considerations. The objective of peak performance in human potential offers the opportunity for mutual goals that benefit to be realized but necessitates a new conceptual paradigm which follows:

| | | |
|---|---|---|
| | Psychology | |
| | Cognition | |
| | The mind | |
| | Leadership | |
| Ideology | | Sociology |
| Intuition | | Emotion |
| The soul | | The heart |
| Business | | Education |

INTEGRATED PERSONALITY

| | |
|---|---|
| Theology | Biology |
| Inspiration | Constitution |
| The spirit | The body |
| Culture | Environment |

The personality or culture animates through all tasks but only through personal relationships can intimacy be created. The experience tests and reinforces spirituality as it is comprised of morals, beliefs, ethics and values. These characteristics emerge from the family, historical context and social class. Ideologies in each stage of life recapitulate to the subsequent generation. Emphasis is on the integration of the opposing forces of free will and cultural collective. In the competition for resources, potential can be equally constructive or destructive. Groups with healthy attitudes and backgrounds are more productive. The belief system, skills, resources, intellect and attitude affect the manner in which an individual or group can learn.

Inner balance is the intersection of attitude and action for the achievement of personal satisfaction, power, esteem, and wisdom. Few are successful at living in a rewarding way that is valuable to themselves or others but everyone could. To actualize potential a person must have a certain amount of freedom, possess integrity and have the guts to take responsibility for their life and use their gifts. Conflict resolution is a very important tenant to equilibrium. Freedom acquired may be in direct proportion to one's moral and responsibility level.

In the event of a discrepancy between doing the painful but right thing and easy but incorrect thing then the individual or group must make tough choices. Unless the mind, heart and soul are aligned, there can be no lasting decision of import. Making the choice means accepting the responsibility for all potential outcomes and consequences. When this is understood and internalized, it becomes a defining structure within the personality or culture. Refinement of moral conduct, higher levels of consciousness and supreme relationships are hallmarks of the actualized individual and basic foundation for order, harmony and balance. These abilities are then available during stress and crisis over time and strengthened through use.

Psychotherapy or coaching must expand and offer flexibility and professional acceptance. A positive and respectful working bond must be established for coping skills to be welcomed and perception alteration to be considered. Repetition that involves as many senses as possible is the cornerstone of learning knowledge and the reflection upon experiences to derive and integrate their meaning. Learning is done through trial and error while adapting to situational circumstances with guidance.

Inspiration is a rare commodity comprised of positive energy and intent. The goal of consultation is to enhance and “abilitate” individual or group functioning and insight. The concept of normal requires varied parameters and denotes what is positive, healthful and aspiring. The consulting relationship should focus on leadership, management and developmental characteristics that promote creativity. Constructive intervention requires a blueprint to follow, the identification of abilities to develop resources, and tools which can instigate powerful adaptation.

### SUMMARY OF THE INVENTION

The invention is directed to a psychological development system for assisting in leadership development. The system utilizes triangulation to qualitative theory, quantitative practice and quasitative research. The system evaluates three things (items) three ways, (methods) three levels (subjective, objective and collective) and that this operation can be done separately or three times.

### BRIEF DESCRIPTION OF THE DRAWINGS

FIG. 1 is an illustration of a power chip according to an embodiment of the present invention.

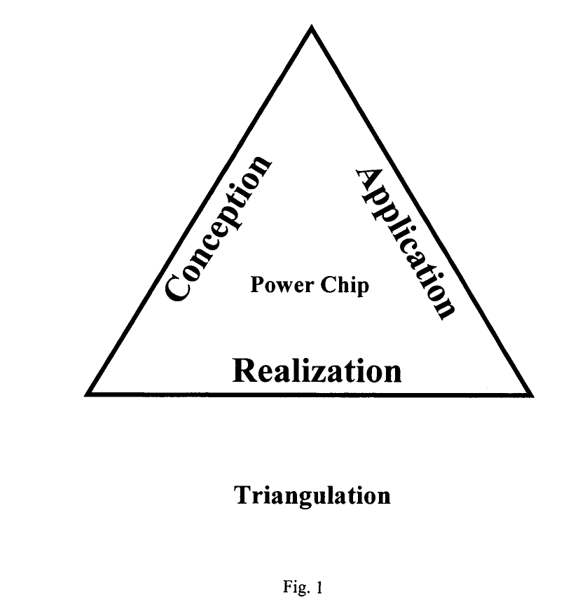

FIG. 2 is an illustration of a level 1 research triad flow chart.

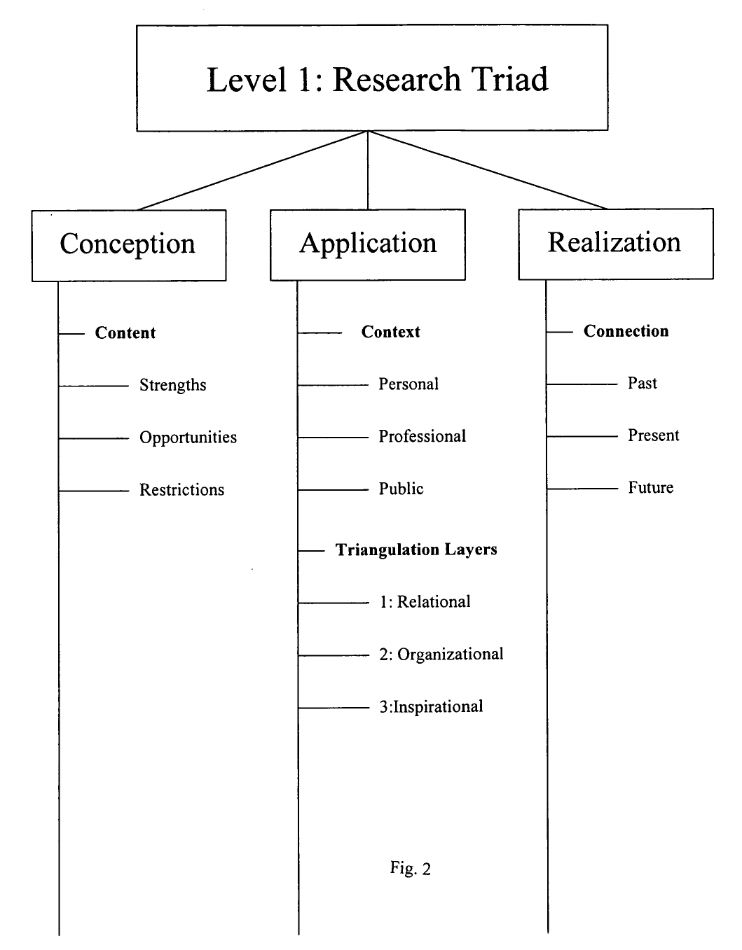

FIG. 3 is an illustration of a level 2 application realms.

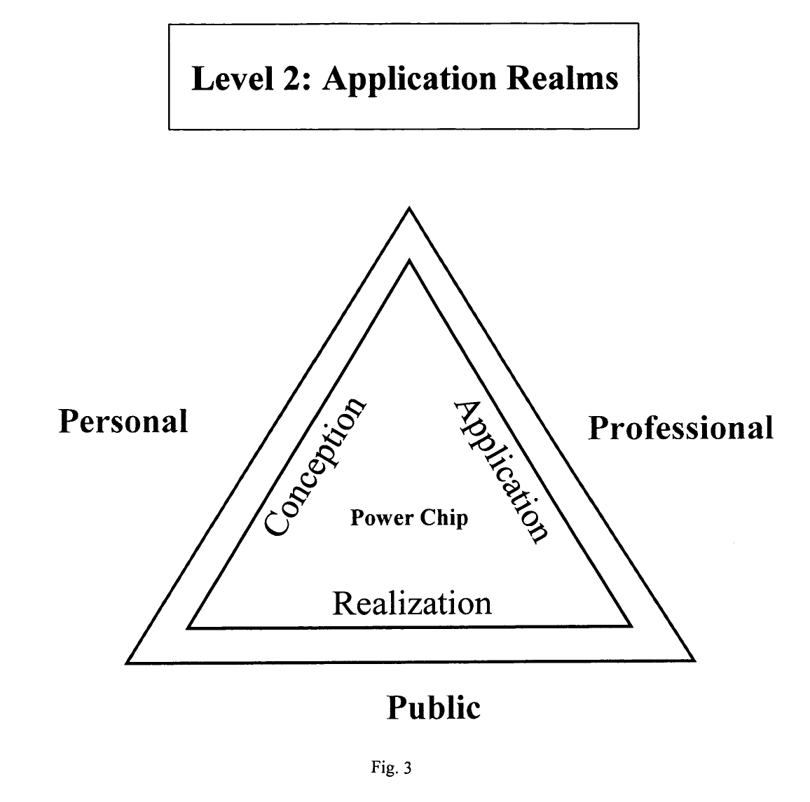

FIG. 4 is an illustration of a sample application flow chart

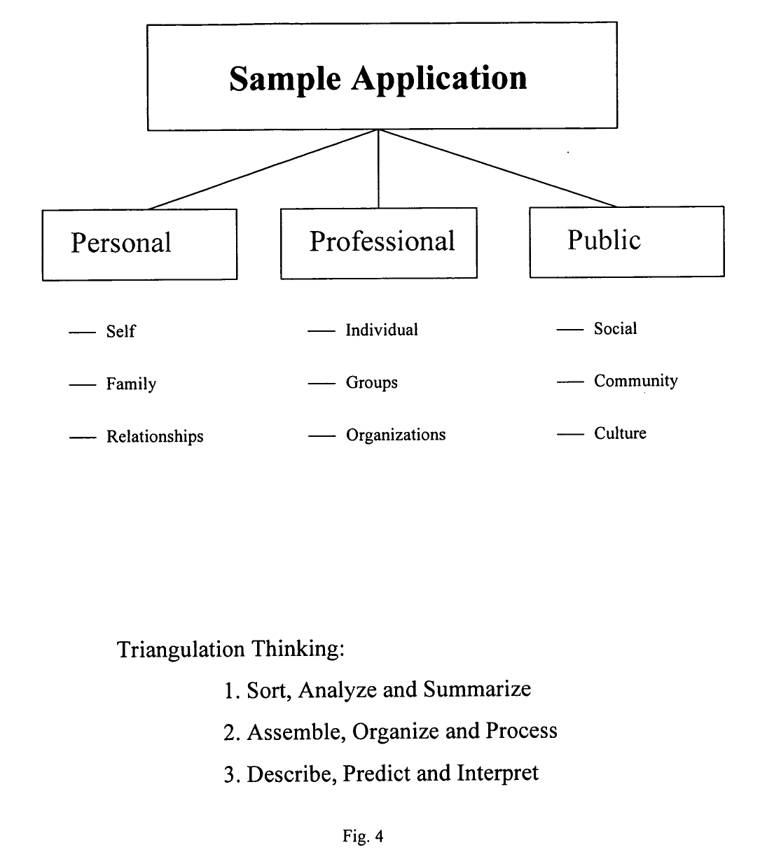

FIG. 5 is an illustration of a level 3 realization of mind, heart and soul.

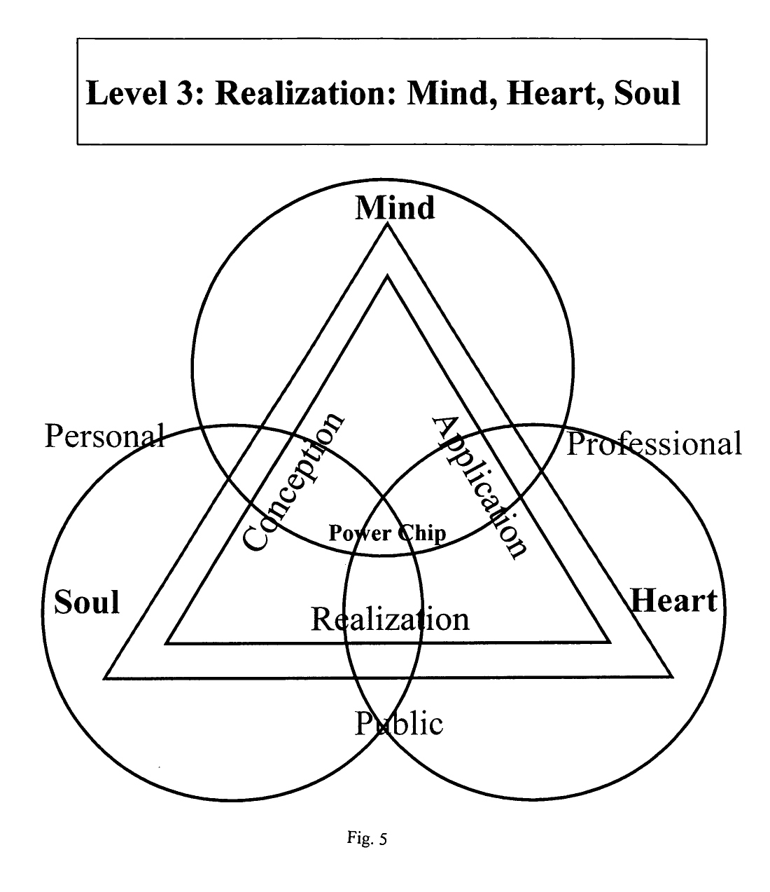

FIG. 6 is an illustration of a level 3 mind, heart and soul flow chart.

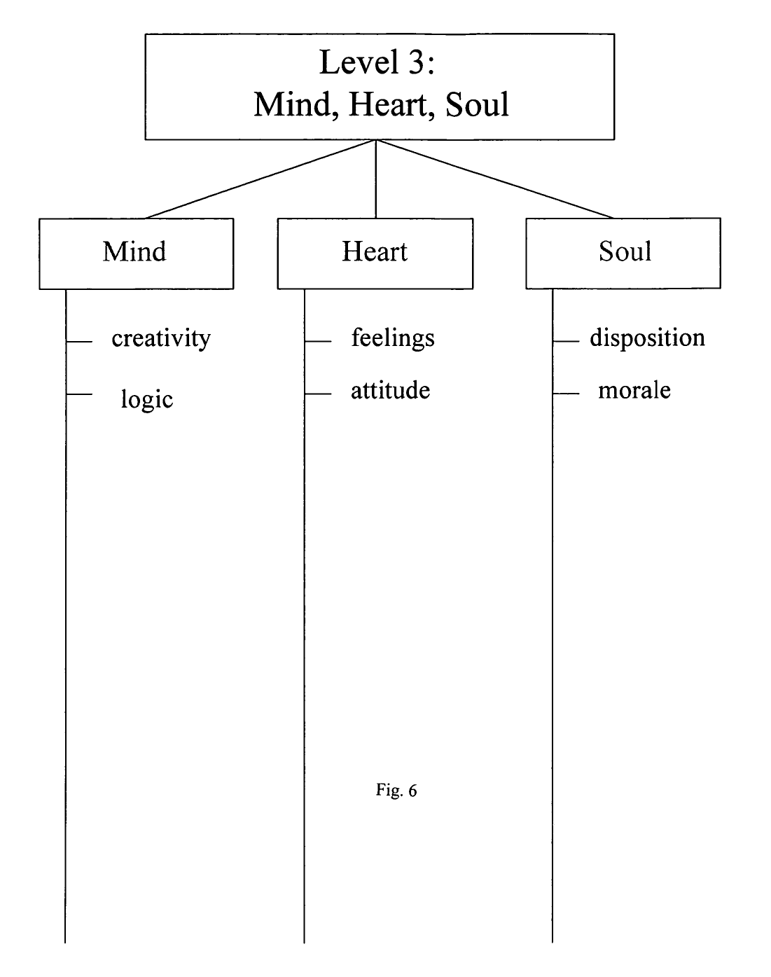

FIG. 7 is an illustration of layer 3 characteristics.

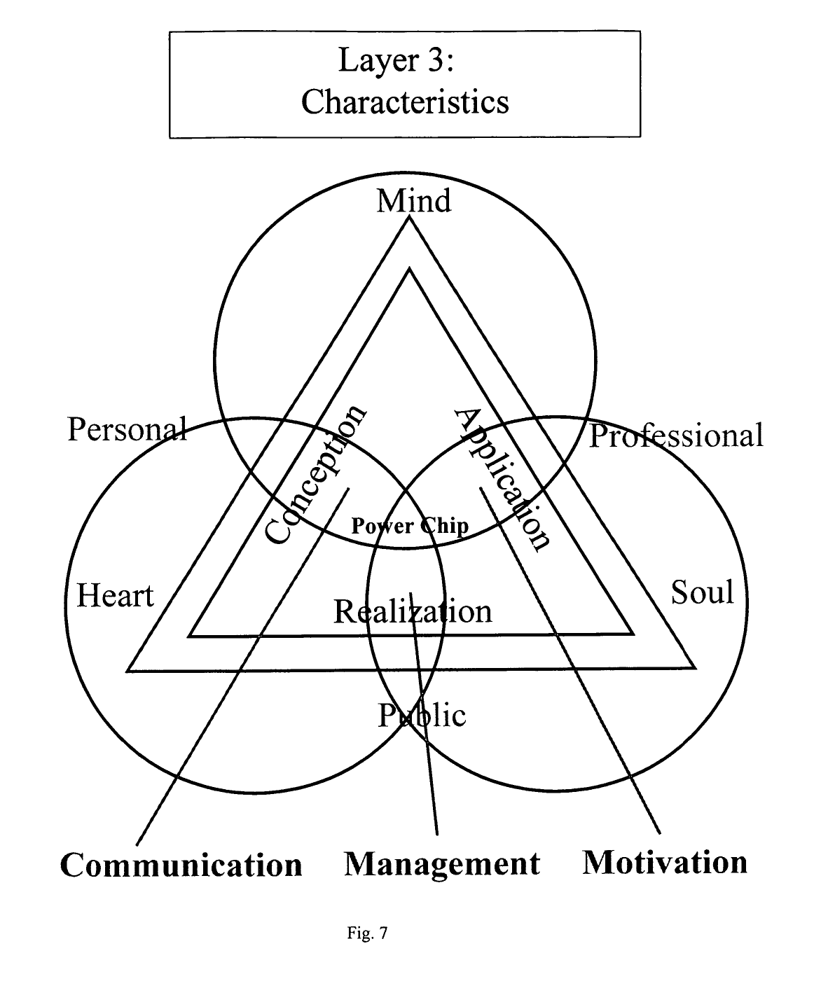

FIG. 8 is an illustration of a layer 1 developmental characteristics flow chart.

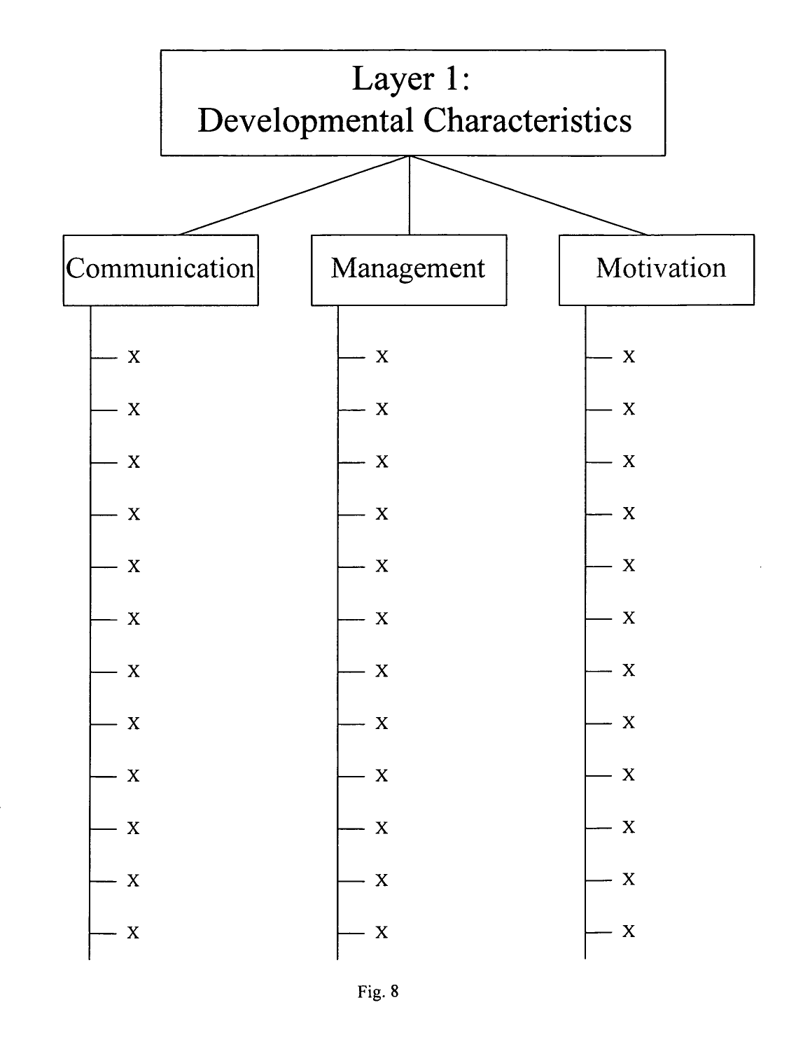

FIG. 9 is an illustration of thematic griding.

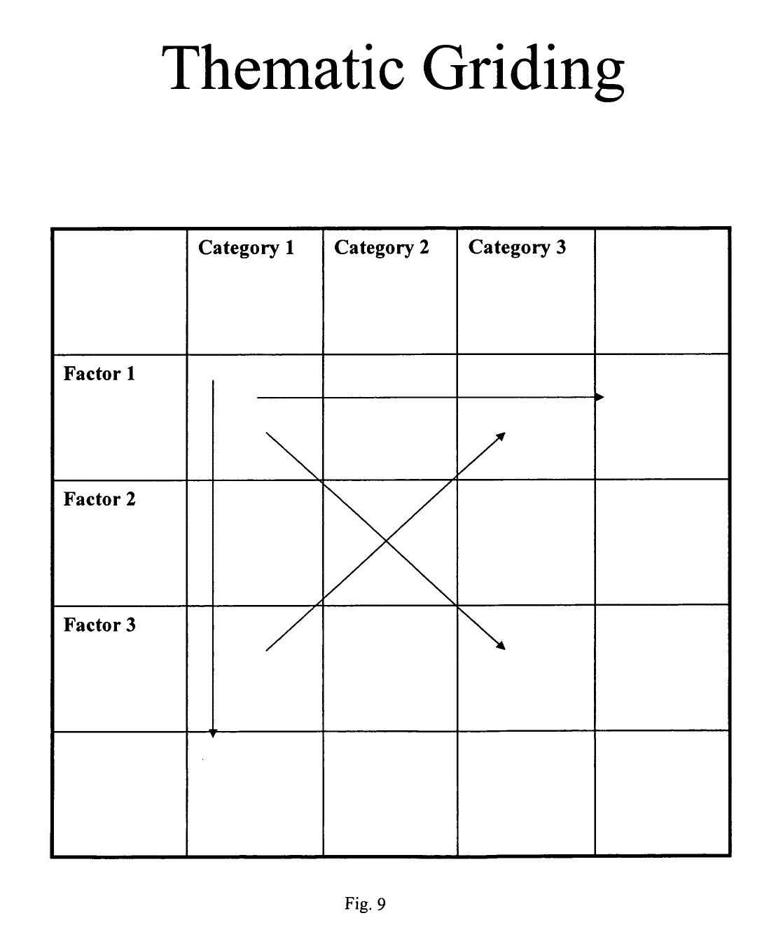

FIG. 10 is an illustration of sample mapping.

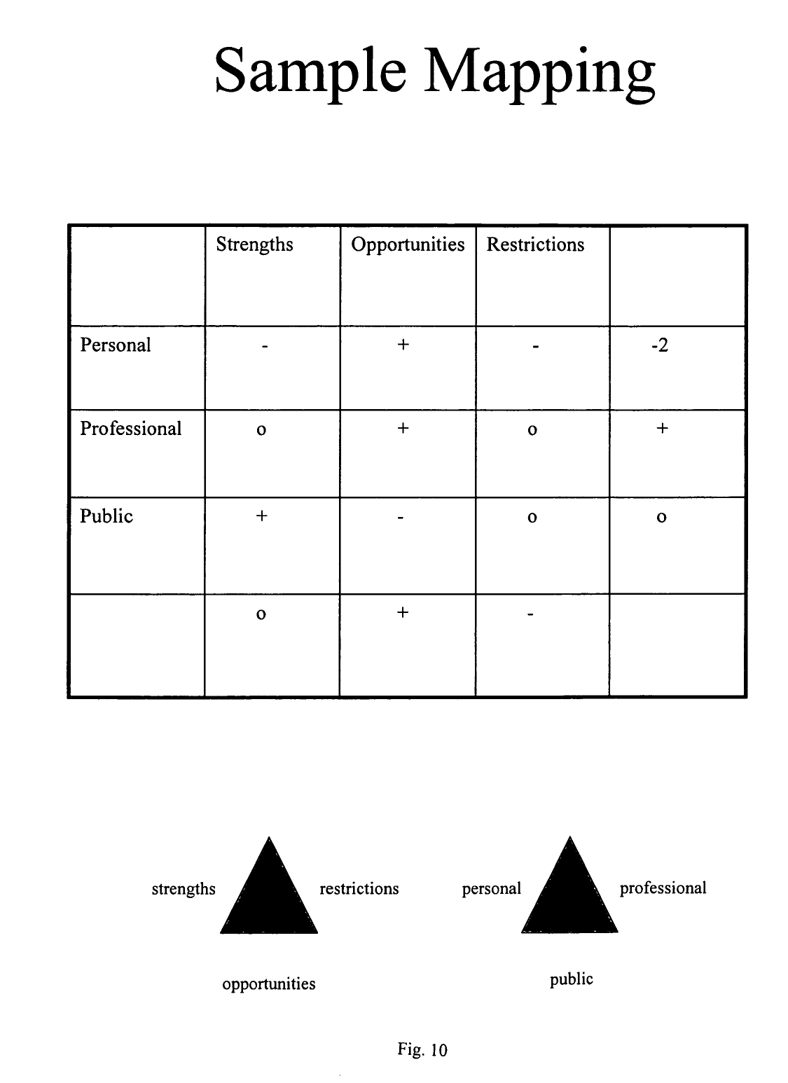

FIG. 11 is an illustration of a Venn diagram.

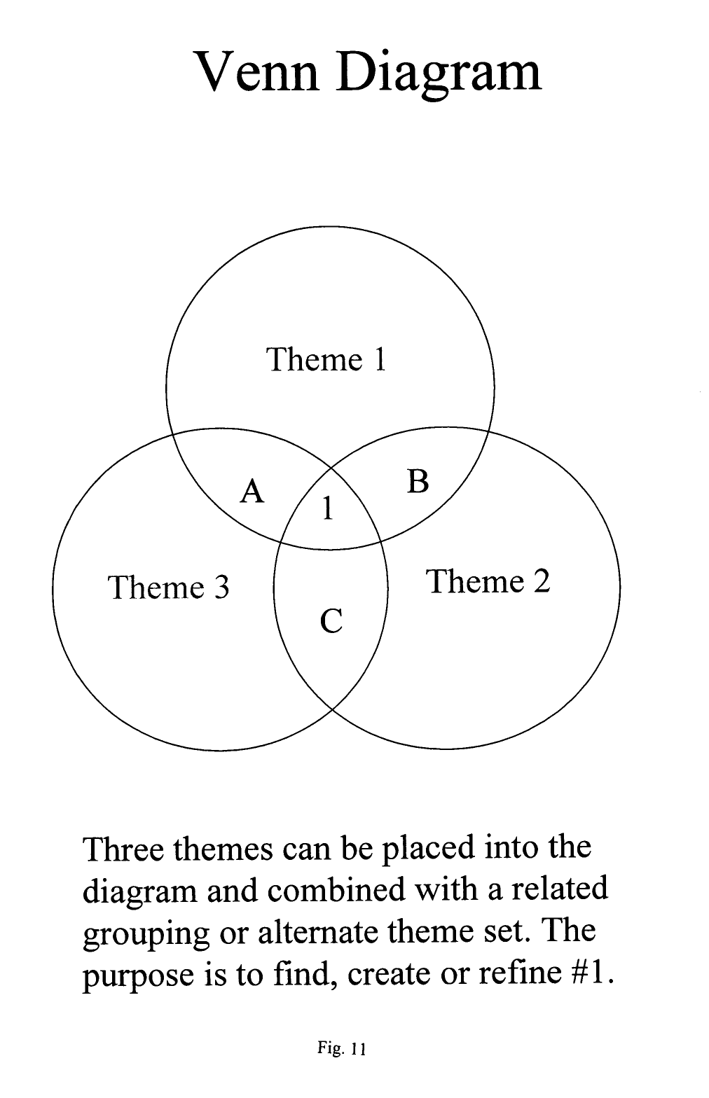

FIG. 12 is an illustration of sequencing rings.

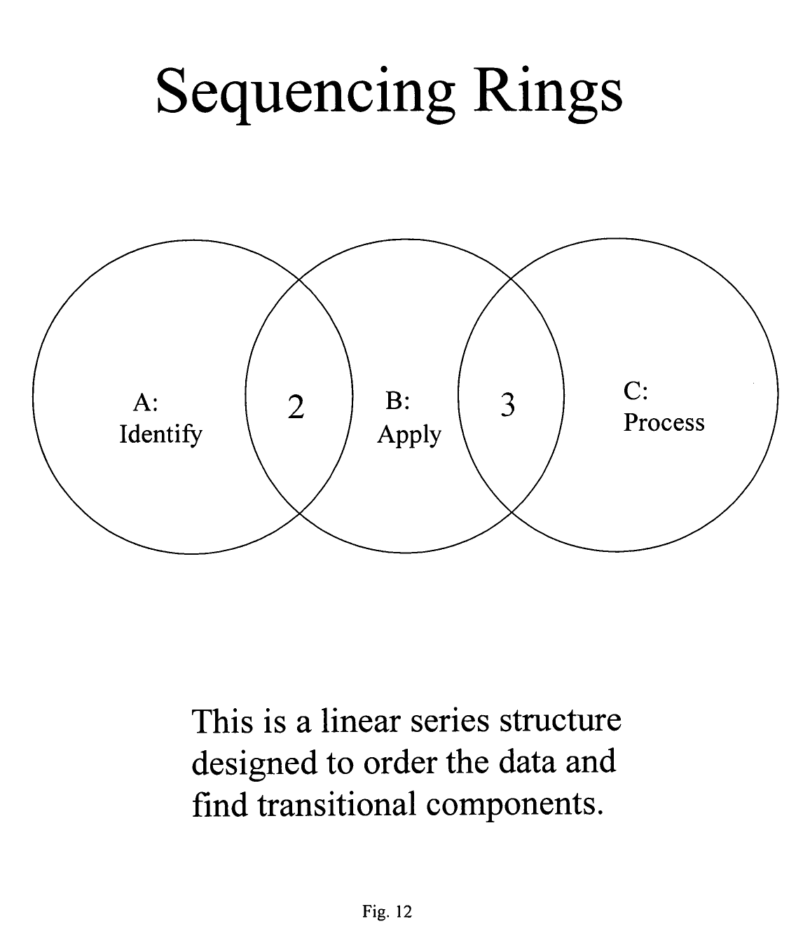

FIG. 13 is an illustration of a vertical strand.

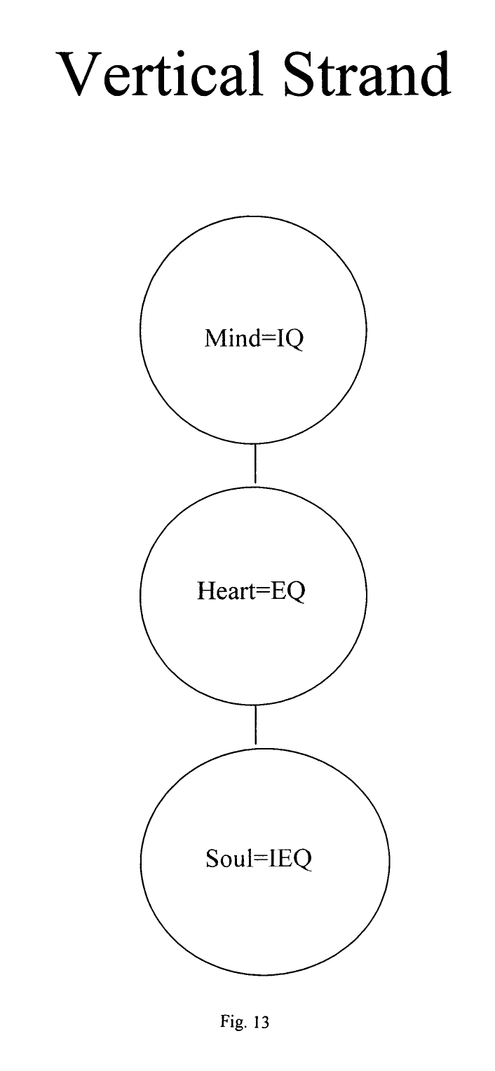

FIG. 14 is an illustration of a research strategy formula according to the present invention.

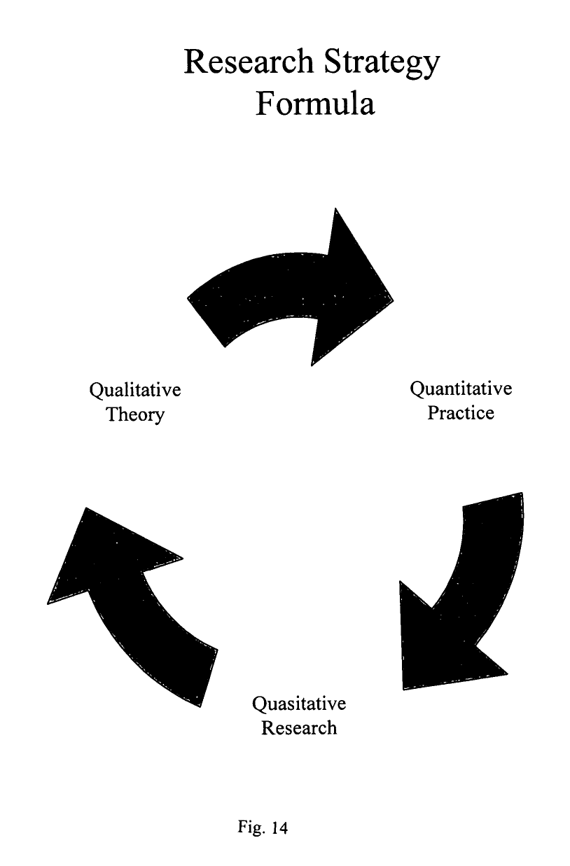

FIG. 15 is an illustration of transcendental analysis.

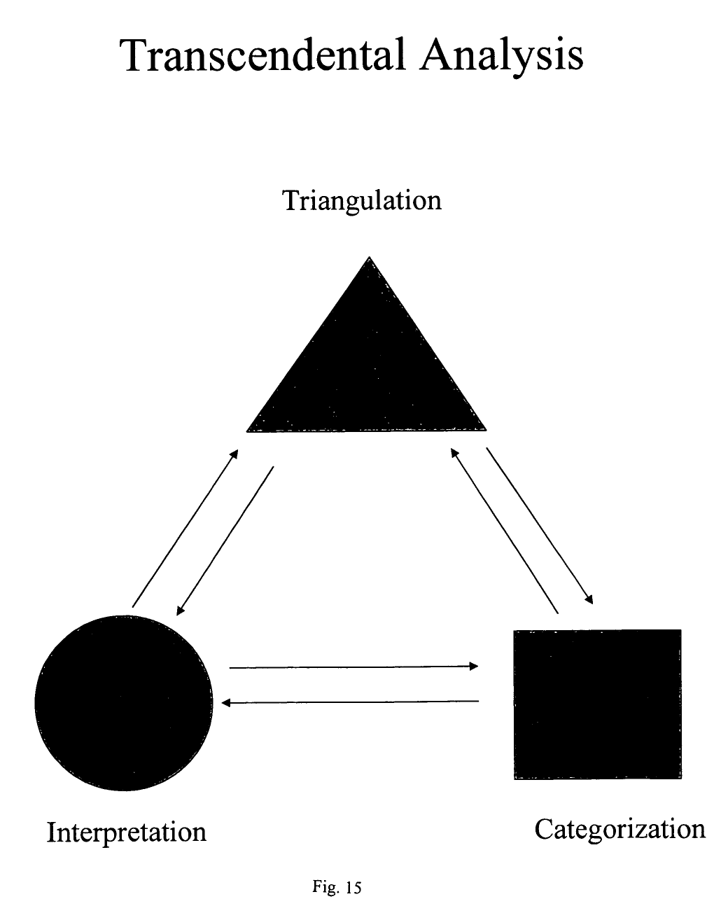

### DETAILED DESCRIPTION OF THE PREFERRED EMBODIMENTS

An embodiment of the invention is directed to psychologically developing leaders. Leadership necessitates adhering to life principles, growing from adversity and recognizing the opportunities that come from not only strengths but restrictions. This invention is concerned with the leader with all their potentials, the instructor we all implicitly are and the genuine executive within when we maximize every aspect of ourselves. Like an engine with all pistons firing each part of the human equation must participate to acquire the synergism to enhance life. By the alteration of perspective or Zen-satori, one can gain wisdom to place into the service of others. This invention is about being a genuine individual but beyond that, it is concerned with becoming all we were meant to be.

The top performer can be a teacher, or a promoter, a maintainer or transformer, however a navigator is the individual who can communicate well with others, manage whatever task required of them, and motivate themselves through any situation and is anew kind of leader that transcends circumstances, situations or even themselves. These individuals have the ability just by being the way they are of creating opportunity where none existed before.

They know they require others to be successful, that they have a mission beyond themselves to accomplish, and recognize their capacities are limited. If we look to the wisdom of the past ages for answers to a broad, fast, informational society the strain of modem life involves, it is clear that everyone and every company needs to be a researcher. The universe has its own force and tapping into flow allows one to become unified with the power source of nature and all the interpretations that come as a result.

This patent introduces several new concepts relating to the interpretive leader who engages in a new type of informational analysis and quasi-research a form of inquiry within the reach of the everyday person. The skills that can provide the most optimum of conditions for personal growth and the standard necessary for professional success can be yours. In addition, the perspective and discernment needed to reveal what is hidden and illuminate what is most essential to the self are critical to what is easily overlooked.

Life is not about problems but the opportunities that develop from them. IEQ is another new concept and refers to the pinnacle functioning possible when individuals or groups are aligned between the spiritual and physical realities. The two poles provide the dualistic foundation for emotional, cognitive and intuitive human experience which is the template for all behavior.

When these areas are developed, the extrasensory and intuitive birthright can be realized. IEQ refers to the gut, instinctive or visceral understanding that trusts, acts upon the information and is the resolving tie breaker for the opposing forces or IQ (mind) and EQ (heart) within the self. The combination of the three results in the conative will or effort put forth.

Also unique to this subject matter is the term “quasitative” or interpretive research that refers to uncovering what is not and is the cornerstone of creativity and innovation. By using certain principles, tools and models a strategy or blueprint can be utilized to achieve objectives. A triad of research methods combined with a formula offers a planning template for literally any objective. Through the application of triangulation, categorization and interpretation success is realized. The principles of life (survival), love (social belonging) and laughter/joy (pleasure) provide the basis for all ethics, morals and values critical to integrity. The response spectrum of quotient psychology provides a new approach to psychology, education and business.

It's not about the problem, it's about the opportunities. It is easy to become trapped by problems that become the focus of attention rather than the key to a new avenue. The current service delivery in mental health reinforces this approach and the past diagnostic approach is evidenced as we move to name, define and therefore identify what our issues might be, what situation must be ameliorated or what can be the next step in any type of procedural process to address an event.

Behaviors are only a part of the picture. The best of us can err and most of us do try but many more can do better and often the shift from failure to success is using the failure as a springboard for that eventuality. Suddenly a child with a diagnosis becomes hyperactivity as one example and much of what we perceive has more to do with the lens we are looking through than the phenomena itself. While an individual may fit a certain criteria for a disorder and become involved in certain treatment regimens with or without medication counseling is limited by its own system design to manage service provision.

Prevention has taken a back seat to crisis and the world has flipped upside down. Consider the average individual who is trying to combat depression. Some will use substances to mask the depression, others will take anti-depressants and seek therapy but most will do nothing due to the stigma society has placed upon individuals who are smart enough to seek an objective source outside themselves. Substances too have a long history of being sought after and homeopathy and a new health consciousness is evident.

All our problems have the seeds of opportunities within them if we will only look at our situations as such. Many of the really tough ones become our defining moments and in a turn of the obvious carry us closer to the incredible human being we all can be in the most positive sense. Not only do our restrictions carry the planning template for change but our strengths give us a compass of where we might go with them.

Anyone by virtue of their societal role is a leader. How well one can lead and what kind depends on self development as well as situational considerations. If individuals and groups can interject a new interpretation prior to a response to a situation neither the situation, or the outcome becomes the important issue. It is not the situation but the response that matters. It is the interpretation that impacts the response to a stimulus that becomes the deciding factor. The outcome may be forthcoming later, or may alter as a result of what we determine our choices to be. If one is not sure of their choices, has severe limitations on their choices or is not cognizant of what their choices could be, then choices become a secondary to the imagination and the ability to alter our reality.

Anyone can take a perfectly good situation and turn it into a negative. We all know this can happen so the reverse then can also be true and a positive is possible to an equal measure. Balance is the law of the physical and metaphysical world. Between those two opposing planes of human experience of what is and what is not resides the empirical world where they intersect and offers us the space where what “could be” can be realized.

When the concept of leadership is applied to whatever we do suddenly the context of our behavior shifts and with it our behavior. Learning, for example, requires not just content of what skills or ideas must be mastered but the environment, history or background of where the information is assembled must be there and correctly applied for the proper connecting to ensue.

The wrong connections are frequently made on the job, in a marriage, with our children. The productive connections build and the former divides or takes away. We are then robbed of our alternatives, dignity and the chance to make changes with others and create the best possible opportunities a situation offers. Everyone is a leader to some degree and within a contextual framework, and having empowerment is a by-product the cooperation of all is needed for the manifestation of a greater good. One can evaluate when their leadership abilities are wearing thin by viewing what is not happening.

It is important to focus on what can be done. Anyone can ruminate upon limitations and put their attention on fear rather than desire. It is natural to evaluate our situational variables in that light. However, to remain there does not provide productive outcomes and allows emotional turmoil free reign. People naturally engage in cyclical thinking that goes around and around which can result in paralysis but if that tendency is used strategically subtle nuances and groundbreaking discoveries can be obtained.

One of the first things individuals and cultures can do when approaching an issue is to reduce things down to their core elements. In most cases it is easy for people to identify two polarities. It is by obtaining the third element that opportunities can become visualized and brought into the foreground of possibility. It is also by doing this exercise that the value of the neutral or space is created to clear a corridor for innovation and experience.

The challenge of the 21st century will be in discerning between what is real and imitation because we function within the parallel realities of cyberspace and inner space a virtual reality is created. Imitation is fake, a copy of the original. It is artificial and pretend and never has the quality of the genuine article. Consider the Cubic Zirconium diamond often substituted for the natural carbon based stone. The manufactured gems appear more perfect than the real ones but they can not cut. They are without flaw which is why they are subject to discovery as being a reproduction.

The lesson is that if it looks too good to be real-what is not present or evident presents the opportunity to investigate why. Real individuals total to a 100 percent and not 1 percent less. They will add up and there will be no variation or gap in their story. As with any copy it is pretend and will with adequate scrutiny prove itself to be false. If in doubt-attending to the information gathered and deducing what is not present will illuminate what is hidden. It is through the ordinary and everyday that the uncommon or extraordinary is discovered.

A geometrical representation for the present invention has to do with three realms that correspond to each type of research strategy that are analyzed with respect to the triangle, the circle and the square.

The Triangle

The Triangle symbolizes the Personal Realm and relates to the Qualitative Research approach. It relates to concepts, integrity and the nature or quality of all things. The gold triangle represents the wisdom of the ages and wealth of life. It also represents humanity and historically pointing upwards it stands for ascent to heaven, fire, and the active male principle: reversed, it symbolizes grace descending from heaven, water, the receptive female element. For our purposes, it is related to the Psychological component and the subjective personality. It is a symbol of observation and conceptual assembly balancing the opposing poles of reality.

The process of triangulation means that the location of an unknown point is obtained by using bearings from two known fixed points. In research circles it is also a method by which multiple data sources are used to provide increased reliability.

Each geometrical construct offers a specific group of three alternatives by which thoughts, feelings and actions can be shaped thus impacting beliefs. Just as a pyramid shape allows for the rapid building up due to its broad structural base. Since the dawn of history the shape has been symbolic for power offering four triangular planes supported by a square base. By uniting and combining two forms architecturally innovation is generated.

For the purpose of this construct the triangle represents the use of depolarization in interpretive activities. It is the culmination of both the subjective and the objective with the additional benefit of the collective perspective. It neutralizes and evaluates what is, to what degree and what is meaningful. The shape corresponds to the strategic process used to gain an organized plan and perspective on process and allows for a framework by which a group or individual can obtain utmost integrity and training in leadership development. The triangle or multi-dimensional manifestation of the pyramid is related to the creative side of thought or right brain operations. Trigonometry or the study of angles and planes concerns itself with the properties of triangles and deals particularly with the discovery of unknown sides.

Triangulation in psychological terms has had a somewhat negative connotation as it has been construed therapeutically to interfere or allow for convolution of process in relationships. In research terms it is a method by which investigators gain consensus and combine data sources to better obtain multiple perspectives.

The idea of obtaining a third element by identifying two opposing ideas is not new but has a rich history and symbolism. The triangle is considered the most simple and fundamental geometric form. It has been interpreted as a female symbol as representative of the womb or vessel as well as a masculine symbol reversed as a chevron. Two other common significant associations are as the Holy Trinity and the symbol of fire. Its shape typifies the power of three sides and is indicative of right brain thinking. Right brain operations are noted for their creative and innovative side associated with spatial, non-verbal, and multi-dimensional capacities with respect to imagery and feelings.

The power of three is universal and is the tripartite nature of the world as Heaven, Earth and Humankind. Historically, three has been the number associated with the soul as four has been with the body. It has been related to the process of birth, life and death (beginning, middle and end) and the orientation of X3 psychologists use to evaluate the ability to place time in the past, present and future spheres of reality. Folklore utilized the number three and historically it has signified fulfillment. It has not only been used as symbol of humankind such as woman, man and child but also the Godhead of three in one union of the father, son and Holy Ghost as the sacred trinity. Therefore, credibility and ethics are components to this paradigm.

Joseph Campbell (1988) writes, “When you are down on the lower levels of a pyramid you will be on either side or the other. But when you get to the top the points all come together and there the eye of God opens.” So this shape is used in our model to denote insight into what is. Kenneth Clark points out that the importance placed upon number symbolism was matched by a strong dedication to geometry and to medieval times was considered an almost divine activity. Everything that is created originates from basic relationships. Consider the compass and the sextant. Each of these items utilizes two points or angles by which to fix a position.

Such as the pyramid structure provides strength due to his triangular shape, it was also used by the ancients to symbolize elevation. Architecturally, the pyramid by virtue of its base allows for ascension and the ability to reach higher that what would otherwise be possible. The triangle is the first of the polygons that can be increased to any number of sides and with more sides begins to look more like a circle which is a symbol of the unity of all the regular polygons.

The pyramid is the most evocative of three-dimensional symbols and represents the world axis. Its apex symbolizes the highest point of spiritual attainment with the body of the structure representing ascent through a hierarchy of enlightenment. In the ancient world the pyramid may have been the site of initiation into mystery cults that took the initiates through the portals of death into the realms beyond to return transformed.

Since the 1960's grounded theory has progressively developed in a way that is consistent with its original conception such that it is considered to be the most comprehensive of all qualitative research methods available. Its theoretical underpinnings are a combination of two opposing forces of American pragmatism and symbolic interactionism and are portrayed as a problem-solving endeavor concerned with understanding action from the subjective viewpoint. Typically this type of theoretical method commences by focusing on one area of study and gathers data from a variety of sources such as interviews or field observations. Then the information is analyzed using coding and theoretical sampling.

Once this is accomplished a working theory or BELIEF is generated with the help of interpretive procedures. According to Glaser and Straus who popularized this methodological approach in the 1960's regard grounded theory as a scientific method concerned with generation, elaboration and validation of social science to meet the accepted canons of good research offering consistency, reproducibility, and generalizability. This approach is considered inductive and is used to explain phenomena or measure specific content into a coherent fashion. In many ways this approach represents symbolically what the pyramid allows for which is to add layer by layer to an existing structure elaborating upon a fixed foundation. Reoccurring themes associates with all geometry types in art and architecture of interest to this approach include:

Reconciliation of opposites

Transcending duality

Finding a Middle Ground between Extremes

Mediating between the Earthly and the Divine Source: Paul Carter, (1998) Dartmouth College

The Square

The Square represents the Professional Realm and relates to the Quantitative Research approach. It relates to numerical representation and analysis, or the frequency and quantity of all things. Historically, it represents containment and safety. The box is often gray denoting the uncertainty of reality and represents the love of knowledge and the application of principles. This form represents solidity that is static, earthly, material and objective. It stands for the rational order in the world, truth and logic.

This shape represents the Educational component, and is the standard we set. It is a symbol of contextual experimentation and inferences. To square something means that two dimensions of a specified length are combined together leaving no remainder balance. To square something implies a lying out or testing of right angels and that the product is any number multiplied by itself. As an adjective, squaring is considered substantial and conservative.

Instrumentally, the square combined with other structures naturally assumes the role of stabilizer due to four equal sides and angles. The process is to adjust exactly offering fairness and just outcomes or to make account. The squaring of the circle relates to the combining of two figures due to it's mathematical relationships in studying properties and operations with the product of three by which to generate a multi-dimensional construct such as a cube.

Historically, this figure is representative of the earth, grounding, context and statistical or numerical value. It is geometric perfection, static, denoting honesty and straightforwardness, morality and integrity. The black box was popularized by Skinner during the second developmental force shaping the field of Psychology following on the heels of Psychoanalysis which utilized the importance of interpretation, free association and dreams.

Conversely, behaviorism was a much more mechanistic school of thought that grounded reality into terms of a stimulus being introduced into an entity or structural construct by which an interpretation operation occurs resulting in a response type. S-Q-R was the foundation of cognitive behavioral conditioning popularized to the public by of pairing certain events together so that either stimulus would obtain the same response. Thus, the first experiments in Psychology used to alter and change behavior were instigated. Frequency of response and measurement were the quantitative methods used to factor and formulate a hypothesis that could be tested ensuring predictive value and substantiate claims of applicability.

The square by virtue of its four quadrants has been associated with the number four and applied through the use of truth and logic tables by which information can be assembled and certain conclusions drawn. The square represents a complete entity comprised of a top, bottom and either side upon which the seasons have been assembled, directional navigation acquired, and the primary forces of the zodiac encompassed. The basic astrological signs and elemental categories of earth, fire, air and water represent the essential energy forces believed by the ancients to sustain the world.

The square is the most frequent shape in the Hindu symbology and stands for order in the universe and the balance of opposites. The square has been associated long term with logic, precision, and left brain thinking. Roger Sperry who was awarded the Nobel Peace Prize in Medicine reported evidence that the two symmetrical parts of the human brain have distinctive spheres of conscious and function in specialized ways (Bleedom, 1999). The left brain is associated with the rational, objective, quantitative, analytical and verbal specializations. In short linear thought processes.

Certain geometrical shapes have an intrinsic power to affect the unconscious and elicit subtle changes in mood and perspective. This property is apparent when applied by a skillful architect or talented designer. For example, visitors to classic Greek sites such as the Parthenon often experience a sense of inner tranquility that can linger for days or even weeks. Similarly, the grandeur of Europe's soaring Gothic cathedrals resonate with potentiation deep within an observer evoking a sense of boundless spirituality (Fontana, 1994).

The most obvious explanation for the psychological power of abstract shapes is that they symbolize certain emotions. Symmetry or rounded shapes represent relaxation and inner peace, while jagged edges and irregular shapes denote incompletion and are symbols of anxiety and anger. It is quite possible that the near-universal meanings of shapes reflect the pattern making ability within the mind (brain) itself. According to Jung, the square corresponds to the temenos or where the drama is taking place and provides the context or backdrop by which things/events are viewed.

There is considerable and firm evidence that certain geometric forms are more pleasing than others. Just as a baby is more attracted to symmetrical harmonious shapes than to unbalanced or uneven ones (such as the human face) and associations with the comfort provided from parents at an early age are formed as paired with those representations. Also when a child looks at inanimate objects; by virtue of their relationship to the “other” object begins to obtain a sense of balance and self awareness which later transcribes into a visual manifestation.

Our feelings about geometry may also be concerned with the aspects of nature itself each state of mind counterweighted and in part defined by it's opposite. This balance theme is evident in the symbolic meaning of the cross where the vertical post is to establish a stand of position (the masculine principle) while the arms to reach out in two directions (feminine principle) and is probably the most wide spread and ancient of all symbols. The intersection is the point where heaven and earth meet and of course the result of this union in the triangulation point of humankind or central apex of both axis (Fontana, 1994).

Consider the Celtic Triple Enclosure, which is an ancient symbol of the human consciousness. The outer square is the part of the mind relating to the physical world of the senses while the inner square denotes the unconscious mind through which the visions of the gods or “other worlds” can be manifested. The middle square is the part of the mind receptive to both the physical and spiritual world. Similarly, the yantra a geometric diagram used for the purposes of meditation, offers some of the most intricate and evocative forms in the iconography of India and Tibet.

The symbolism of geometric shape is used in those cultures to maximum effect as sacred works of art and as a focus for deep meditation. Each of the complex forms is essentially a depiction of the universe and the forces that drive it. By meditating on a symbol and moving mentally towards its center, the seeker is made aware of the multiple layers and deep levels of meaning.

The shapes that are most common to yantras (squares) and mandalas (circles) are circles, squares and triangles. A variety of combinations of these forms can produce extraordinary visual effects conveying the idea that nothing exists except for encounters between various fields of energy just as a rainbow is created when light, water and visual observation come together. By meditating on the yantra, the mind is gradually able to unscramble the sets of relationships which give an illusory sense of permanence to the world. The Sri Yantra is a famous and powerful aid to mediation that increases in complexity from the center outward as the pattern assists the observer to look symbolically back to creation both of the universe itself and the acts through which the mind brings the outer world into existence. For this paradigm it represents the scientific realm.

The Avalokiteshvara combines the two forms both circle and yantra (square) and is considered a symbol of compassion. Mandalas have been long recognized by Psychologists as clinical material often presented during therapy and are thought to represent an attempt of the psyche to recognize and integrate the conscious self with the unconscious self (Fontana, 1994). Another use of the square is the maze which for ancient Egypt symbolized the path through the labyrinth of life creating a pathway to orientation of reality and reflects an inner journey through the confusing and sometimes conflicting pathways of the mind in every culture until the seeker reaches its centre and discovers the essential reality of its own nature.

Four is considered the number of mankind and is associated with wholeness, completion and to the Chinese is the number of the earth. Numbers have historically been seen as unreal templates of creation and therefore symbols of perfection. In the Greek and Hebrew alphabet a number was assigned to each letter and great importance was attached to the numerical significance much like the elemental chart of Chemical compounds which has an atomic weight, a number and a name.

Carl Jung has argued that symbols constitute a universal idiom and that abstract shapes are encountered world wide. He asserted that are more than just historical and cultural signposts but can help us to a fuller understanding of our own minds. This is especially true if a system can be devised that would utilize these language representations and provide a mode of applicability by which multiple functions could be realized. Just as the accountant utilizes a spread sheet to keep track of numbers and organize and make sense of the content within each cell so can individuals do as well with respect to any other kind of operational function.

For example, an accountant will list his numbers organized into groups or columns to keep track of what they are doing. Once those totals are forthcoming a good bookkeeper will then check the values against the totals gained from the compiling of the values of the other axis. By cross referencing the two errors can be revealed and a checking system instigated to ensure accuracy.

The idea of sorting, grouping and categorizing is best illustrated and employed by the square as a spread sheet, text box or picture and is the site of analytical thinking that can transcend circumstances. Herda (1999) talks about the transcendental turn when a particular viewpoint is altered slightly or as such turned onto its side into a diamond. Note the symbolism as the jewel of humanity or the creation of the world.

The diamond also represents wealth as one of the four suits in a deck of cards or the whole playing field. With respect to the carbon stone “dia” means through and it is the hardest mineral known of great brilliance. The vesica conversely is the overlap between two circles as is considered a mandorla (or almond shape vesica) and is the universally recognized shape for a portal or doorway and has many references to fish shape or the all seeing eye when it is positioned horizontally. The shape overall implies a union between what is earthy and divine.

It is true that the square has represented humankind but the circle is considered the ultimate figure. It is important to note that two triangles side by side will create a square and that inside a circle many triangles are contained within.

The Circle

The Circle symbolizes the Public Realm and relates to Quasi-research or mixed design. It refers to subtle nuances and illuminating what is not evident. It is the Business, or intuitive cultural component. The circle historically has represented infinity, perfection and the eternal. It is often represented in blue that is indicative of the universal flow and is used as a representation of the interpretive data recycling that occurs during any kind of extensive effort. It is a symbol of connectivity and change and the manifestation of our collective creativity.

When each of these elements are strategically combined and focused toward an objective our restrictions become instrumental and the ordinary-incredible. To circle something implies an area of action or influence or to move or revolve around a fixed point of reference. The combination of the three geometrical shapes used together in a specific procedure provides an algorithm for solving problems that can be used literally, as a cipher, or in symbolic logic.

A series of circles one inside the other is widely accepted as a symbol of the cosmos. It is a universal symbol of extensive meaning representing the notions of totality, wholeness, the self, eternity, the infinite timeless and cyclic movement. It is a combination of the feminine and masculine power and the perpetual motion of everything that moves.

The circle is also absolute zero symbolizing the emptiness of the embryo and potential of what is not there that can be potentially be created. It has magical properties as a protective agent and indicates the end of the process of individuation or the striving of psychic wholeness and self-realization (Julien, 71). For Jung, it was the ultimate state of Oneness or the antithesis of the square (lowest state of humanity that has not achieved inner perfection) with the octagon between as representative of each entity.

The model presented here also supports that polarity but offers the triangle as the meeting ground of the two points. Indeed according the quotient construct the circle is one level of the triangle forming the point between the two poles of reality which comprise of the physical, spiritual and between them the empirical reality. It houses a combination of what is and how much offering an evaluative form by which weight can be ascribed. In this way meaning and understanding are obtained through the contrast of opposites.

The circle has many interesting associations and appears in numerous forms in various artistic creations. As a symbol of infinity without beginning or end it is the ultimate perfect geometric symbol that has been used to depict halos, rings, wheels etc. . . . Just as a structures shape, color and essence denotes its best use so do these elements configure to arrange thinking patterns for optimum functioning and results.

The half circle a symbol of incompleteness and promise is manifested in the rainbow shape and is considered to touch or communicate between both realms of heaven and earth. Rings have been used as symbols of union, eternity, magic, and of authority and status. The Koran says King Solomon had a magic ring that could transport him to a celestial sphere where he could rest from the affairs of state. The snake or dragon with its tail in its mouth continually devouring itself and being reborn from itself symbolizes eternity and the cyclic nature of the universe expressing the unity of all thinking which never disappear but simply change form in a cycle of destruction and re-creation. It is also the alchemical symbol for chemical change and a representation of mobility as in the form of a wheel. Rose windows for example use the circle geometry three ways:

Manifest—impact of the structural composition

Hidden—relationships and proportions of the parts

Symbolic—a representative shorthand where figures represent different things.

Vesicas or mandorlas are the ellipse figures that occur when circles overlap or intersect such as what occurs in a Venn diagram or series of rings. In symbolic logic, a Venn diagram represents the intersection of two sets and is an adequate symbol for the intersection of Art and Science. A vesica horizontally is considered the all seeing or omnipresent eye that leads to the soul, while the horizontal representation is typically used as an almond shape aureole.

The wheel because of its ability to turn has been associated often with chance and fortune or the sphere as a representation of inherent instability. This panel relates to intuition and combining of both creativity and logic or a bilateral approach to thinking which uses parts in combination to reconfigure something new. Appropriately to round something off such as a number implies that is made complete or finished.

The squaring of the circle can be seen in the Indian or Tibetan mandala and is essentially a vehicle for concentrating the mind. It is important to note that the mandala often contains a square. Carl Jung says that the circle symbolizes the processes of nature of cosmos as a whole and that the square refers to the universe as projected by man. However, if the cosmos is representative of the universe and the square as a representative of the physical earth then the role of the triangle between the two takes its role as an entity in it's own right as the empirical median providing the connection between the corporeal (circular) and temporal (angular) planes.

As with any dynamic force descriptors for the explanatory mechanism of the circle can be considered as change, movement and a process that occurs over time offering strategies for multiple determinations. The recycling of all creation resulting in the evolution of reality develops the verification comprising induction and deduction and links imperative constructs together in an order that works unilaterally offering a mixed design or quasi imperative by which to address and navigate existence.

The assertion of this system is that the combination of the three shapes sets the stage for innovation by enhancing imagination and fostering intuition. The result is an integration of what can be considered previously opposing concepts combined together to form something new. This concept is evident in the practice of squaring the circle and the mathematical operations used to tease out answers by using known concepts to obtain what is not readily apparent.

Combining the two has special significance as the reconciliation of the infinite and that which is finite. The squaring of the circle historically has been the symbol of establishment of heaven on earth. It is the quintessential attempt to rationalize the irrational. The most beautiful of examples of squaring the circle is provided by the mandala. In Sanskrit the literal translation means circle, center or Holy Circle and is essentially a vehicle for concentrating the mind.

A mandala often contains a square as well as a circle even if the square does not square the circle the symbolism is there. Triangles are often used as well. For Carl Jung the circle symbolized the processes of nature or the whole cosmos and the square as the opposite refers to the universe perceived and projected by humanity. For Jung the ultimate squaring of the circle came through the combining of angle and arc in the form between the two as represented by the octagon. For the purposes of this construct system, the circle symbolizes the universe and the cosmos while the square is nature and the earth. Between them offering the best of both worlds yet completely independent is the triangle which completes the basic geometric set.

The great pyramids interestingly enough were considered to square the circle and reconcile triangle and square. Carl Jung proposed that the artistic function of creating a mandala each day provided a snap shot view into the psyche and that through the act of creating the figure and altering it as a matter of course the health or balance of individual could improve as related to the activity by which an individual could engage in a rare form of self healing.

The golden ratio which is the successful integration representing the golden mean represents the reconciliation between two opposing extremes. A vesica pictorially demonstrates the intersection or the duality of the two circles (or more) as depicted in a Venn diagram integrating duality as well as common ground.

Each of these shapes works well for the research operations assigned to it that provides a planning template by which individuals and groups can address concerns, realize dreams and resolve conflicts. The power of words and numbers has long been a subject of introspection and interest to scholars for a multitude of reasons. When those two elements are combined, signs that are indicators and symbols which are representations become critical to the conveyance of understanding the hieroglyphs which are both.

The power of symbolism is literally everywhere in modern times and finds manifestation in campaign slogans, business logos, short hand and of course artistic expression and mathematics. The combination of the two is what reveals the weight or magnitude of a pairing although initially it has a neutralizing effect which objectifies the matter under study.

Torrance (1979) identified three thinking and behavioral styles with respect to individuals and groups left, right and integrative reminding us of the transcendence available by utilizing the opposing construct of paradox and balance. Considerable interest continues to develop by educators, businesses and psychologists regarding the conceptual thinking styles associated with the physical structures associated with right and left hemispheres.

The use of geometrical shapes as representations of a related conceptual construct allows for enhancement of those thinking types and provides an application for a multitude of uses across disciplines. A procedure can be applied and used as an algorithm to solve problems, make decisions or resolve conflict requires a set structure that individuals can use to interpret information and make determinations about what it is they seek to do. For example each shape can be utilized three ways.

The triangle is comprised of planes, angels and points of reference. The square can be used by quadrant, or as a grid solving for x, y, and z. Finally, it can be used to obtain a context by observing what content is in the box or outside of it as well as what is not. The circles can be used to composite as in a Venn diagram, they can also be used as a sequencing tool (linear) or finally to link concepts in a series of rings. The use of these difference layers of understanding is conducive to wisdom, performance enhancement and innovative solutions.

The circle can be combined with itself to create a Venn Diagram by which themes can be assembled and new configurations created by which to accomplish an aim or to obtain hidden or elusive resolutions. The circles can then be pulled apart to be utilized into a linear fashion representing past, present and future even short term such as a given sequence.

Finally with a further separation of the rings and a turn of the linear presentation linkage between conceptual materials are evidenced and can then be contrasted to the respective part of the human psyche plunging the depth of self knowledge and the process of individuation in the realization of ones' own essence/identity.

Even the ancient Egyptians visualized life everlasting as beginning with a journey of death where the KA or life force leaves the body for judgment of the SA or soul to recombine them into the AKH or spirit. The significance of this journey is vast as the KA is a representation of the mind (EEG) and the SA in the physical manifestation of the heart is weighed to see if it balances against the feather of MAAT to see if things are the way they should be. If so, the two can combine together once again and renter the living world and enjoy all it's pleasures much like obtaining heaven as this utopia is for all of eternity ensuring immortality as opposed to oblivion.

These forces can be considered as the brain activity of person KA or life force (10). The second as the SA (EKG) while identified as the soul is thus represented by the heart (EQ). The third component a combination of the two which is termed as spirit or AKH for us is the drive force, gut instinct and free will (ESP). If there is a physical manifestation of what is termed in this construct (IEQ) Intuitive Extrasensory Quotient located in the abdomen or area of visceral response and somatic energy. These terms utilize the mind, heart and soul together as they function within a body or physical realm between the planes of a metaphysical or spiritual opposite.

Jung wrote extensively about the circle as a representation of the personality and stated that when an individual through struggle comes to themselves they are able to accept who they are. In doing so they are able to become reconciled to themselves and are thus able to be reconciled to adverse circumstances and events. A modern mandala is an involuntary confession of a peculiar mental condition.

People who have been through trial by fire who have obtained the peace one can only feel after a long and fruitless struggle has ended describe their experiences in such a way as to evidence a centering of themselves within. Such a person knows that what is wrong within the world is wrong in them—if a person can deal with what is askew in their own psyche, they have done something real for the world. (Storr, 1983).

Carl Jung further proposed that when an individual fails to acknowledge a creator, egomania develops from this mania neurosis or sickness ensues. To serve a mania is undignified and detestable but to serve a higher power and purpose is full of meaning and promise for the act of submission is to an invisible force outside the self.

The soul spark of humankind houses the inner most divine essence of humanity using symbols to characterize the deity in them, in nature and the world. The fact that images of this type have a significant and therapeutic effect upon their authors or creators is empirically proven and readily understandable as they represent bold attempts to recognize and assemble opposing irreconcilable differences and reconcile hopeless splits.

This is also true of the fight or flight dilemma in which a person is either a victim or an aggressor who engages in violence. In finding a third alternative victory from either extreme is assured. Any attempt in this direction has a healing effect and purposefully empowers the individual to take action and claim responsibility for their own outcome. Nothing can be expected from an artificial repetition or deliberate imitation.

For genuine and true outcomes are the sole products of sincere spontaneity. Jung puts it well when he described the recycling effect of the circle or mandala as encompassing 1) formation 2) transformation 3) and recreation. This sequence is also evident in the algorithmic formula used to cipher and navigate through adversity using each of the geometrical designs. By formulating items upon the triangle one can neutralize polarity. Using a grid (open) or text box (borders) and spreadsheet (expanded truth table) the box transforms data dependent upon how it is utilized. Finally in the process of revisiting through theory, practice and research something new is born.

Einstein also discussed the importance of finding clarity from chaos, finding harmony thru order and realizing the good as a result. In today's society negative connotations have resulted from treatments that offer a diagnosis as a way to give name to what they are trying to identify (OX). The next step of the process is providing some type of curative treatment (TX) that is not typically a product from within but something that is done to a person and finally a prescription in addition to or in case of.

This construct proposes triangulation, categorization and interpretation. This empowering method offers a planning template by which to organize the three contingencies group them accordingly and by manipulating the material obtain take away conclusions. This series and process aligns with identifying the condition or content by which to discern the issues. Secondly, the situation or the context in which occurs is evidences and finally implementation of an action plan can be overt through the connections made by redefinition.

For Jung the circle was a living representation of the self—the path to the center, to individuation as the ultimate insightful expression to combat the confrontational opposites we are exposed to in nature which disorient and impair our ability to cope, manage and deal with the challenges implicit in life.

Finding it, pulling it all together and putting it out there for others to use is the greatest of satisfactions. It is also representative of the essence of leadership behavior which always implies the guidance of others vicariously or directly. The following passage from Jung's book Dreams sums up the relationship between the two opposing forces of the personality it a meaningful way.

It is evident that the human psyche possesses layers that lie below consciousness and that there could just as well be layers lying above consciousness. Thus the actual conscious mind can claim only a relatively central position and must accept the fact that the unconscious psyche transcends as it were and surrounds it on all sides. Unconscious content then connects it backwards with physiological states on one side and archetypal data on the other.

It is also extended forwards by intuitions which are partly determined by archetypes and subliminal perceptions dependent upon the relativity of time and space in the unconscious. The triangle symbolizes the tendency of the universe to converge to the point of unity consequently the conscious mind (subjective) and in conjunction with the unconscious mind (alchemical objective) merge to form the collective total.

The measure of something becomes the juxtaposition to the opposing poles of the weight of a thing and a number thereof. For example, Umberto Eco points to the triad of terms located in the Book of Solomon “numerous, pond us, mensura” to imbibe God as the geometer. This triad aligns with the use of geometry in three ways 1) manifest: that which makes the most impact what is evident. 2) the secret of the relationships and proportions of the parts and 3) symbolic a type of shorthand where geometric figures represent different things.

This invention is based upon a paradigm of thinking that encompasses a tri-research approach which is the foundation of the formula designed to analyze information. The formula is three things (items) three ways, (methods) three levels (subjective, objective and collective) and that this operation can be done separately or three times. Each time obtaining another nuance or takeaway. A takeaway is similar to a mission statement but is based upon an interchangeable three word synopsis.

The graphic for the incorporation is based upon a three strategy research model which is the triangle which symbolizes qualitative approaches (words) that utilizes triangulation as one application by a trio of reinforcement of data sources and quantitative research (numbers) that uses thematic griding in the box or factor analysis or frequency distributions which also has multiple applications and the mixed design as symbolized by the circle (WNS).

It is a combination but the other side of the paradigm model, just as one can have things they are born have a leaning towards and they can learn skills (nature vs. nurture) and those things that are developed (combined). Someone can be a born communicator, and learn organizational skills, and with motivation develop those things so are in effect a “hybrid” or a conglomerate of three becomes more than the sum of its parts equating to integrity.

The triangle, square, and circle function in the apex between poles of reality for example there is the metaphysical side or spiritual end (SQ) and the physical or (PQ) and in between them the three planes of cognition which entails emotions (EQ) and intellect (IQ) the combination of these poles results in (IQ) which is an integration quotient that is based upon the intuition/extrasensory component to humans encompassed in the SOUL and is the seat of BEING. It is value based and has to do with guts, intuition and the belief system.

The three combined result in behavior. The other side (EQ) is the emotional house of feelings and is the HEART of an individual, group or collective culture. It is morally based. The (IQ) is the hard-wiring as opposed to the soft-wiring of the emotions and relates to thoughts and thinking patterns. It is the left quadrant; the (EQ) is on the right and the (IEQ) the point of the two where assimilation and process takes place. EQ relates to the qualitative piece is relational and utilizes a quantitative and mixed research design.

The IQ is quantitative and organizational and utilizes qualitative and mixed methods. It is the ethical portion. Each of these entities is part of the conscious mind. Finally the mixed is a “quasi or quasitative research” or mixed, partial approach that can use both the qualitative and quantitative pieces operationally. It is comprised of the quasi-experimental, operational and thematic segments.

The formula is basically a multi-variate triangulate of three separate methodologies as symbolized by geometric shapes conceptually. It is a non-polarized model that purports creating the space to illuminate that which is hidden. Discovery is finding, Recovery is regaining and Uncovering is revealing. It takes our passion (soul) our compassion (heart) and our impassion (head) to assemble and hang our themes upon them.

This model purports a shared leadership paradigm where the collective is the combination of the subjective and objective. The OD objectives are to utilize the three established styles of leadership charismatic leader, the transactional manager and the transformational developer into a transcendental being that everyone is capable of becoming.

Each of the paradigms pieces utilize the values of ought, naught and dot or weighted value which is neutral in essence. Dot is just the space where potential and opportunities are created. The poles evaluate the assets and liabilities and provide the spectrum placeholders if you will for the plane to operate.

The positive and negative poles also have a neutral between them which is the area this invention is interested in. The basic ideals are all of part of an identification, application and realization cycling. They encompass the conceptual-ideas, the task—what you're doing and the process or operation of how execution occurs. The reality spectrum is the poles and triad planes as follows:

| | | | | |
|---|---|---|---|---|
| (meta-physical) Qualitative | SQ | EQ | IQ | PQ |

| | |
|---|---|
| Quantitative (Physical) | =IEQ |

Academics are concerned with not only what is in Skinners Box, but what is outside of it's borders and what is NOT in it which could be conceptualized. Leadership development in this paradigm of models are the relational, organizational, and inspirational categories more succinctly expressed in the communication, management and motivation aspects . . . Formula has a mathematical expression of 3×3×3 to the third power or ×3. Under the triangle categories and themes are operationalized and result in a takeaway.

With the grid, one solves for x-axis, horizontally and y-axis vertically, and z in a cross functional formation with a central takeaway related to BELIEVE, THINK and DO which necessitates that the task or project manager in conjunction with leadership development and research analysis provide individuals and corporations and more communal entities with resources necessary to be competitive in today's global marketplace. One's resource base is time, energy and money which corresponds to the three ways the research tool works with words, numbers and symbols. We have to create the space and can often not identify what's there until we identify what is NOT there.

The cipher is analogous to Einstein's universal sandwich of matter, space and time. These things are accomplished in the realms of the personal, professional and public arenas. We use the tri-research approach and strategy in the application process of triangulation, griding and recycling. These operational constructs are used in the three PPP realms and consist of the basic principles of Life (quantitative), Love (qualitative) and Joy (mixed or quasitative). It includes 5 response (anger, angst, anxiety, apathy and action) or the fight, flee, freeze, fry, and figure spectrum in the 3 key critical areas of functioning. This formula is completed by the analysis and development of varying tools that are employed to evaluate and by which to derive meaning so the creation of new insights and applications can be manifested.

Finally the competencies of communication, management and motivation are the result of the relational, organizational, and inspirational categories that are linked significantly to the people, task, and situational leadership taxonomy and correspond to the born, made and developed (nature, nurture and combined category). Each of these sectors in this linkage model includes a layering effect and associated synergy. This occurs externally, internally and eternally from the subjective, objective and collective realms. Finally a Venn diagram depicts those aspects of IEQ cognition, sentience and intuition which comprise the process elements. Basically this invention is comprised of a template that utilizes a tri-research strategy and the formula but each model can also stand alone. Combined they are the integrated paradigm that comprises the research, development and training consulting services.

In a complex society where individuals are not only removed from many of the basic functions in which they must interact, a lag is most apparent between the pace of technology and the ability of individuals, corporations and business entities to cope with change. What can only be described as a reality rife with decisions that were never before relevant professionals and laypersons alike require a new method by which to combat the polarization of existing methods such as the pro/con model, SWOT analysis and various forms of decision making. SOP Proposes a three-way analysis that utilizes each of the realms in which individuals function also provides a creative framework for entities to identify issues evaluate objectives.

According to Covey, (2003) strength training is an important part of being ready to lead. He compares being “fit” against the traditional idea of physical readiness to perform a feat that requires agility, strength, preparation and stamina. Without the proper preparation, individuals, teams and groups of departments are not able to manage and process the massive amounts of information a data society entails nor are they ready to sufficiently integrate the required information into contextual structures that can hold information in such a way as to be used on multi-levels with a variety of functions.

The ability to utilize, access and identify strengths is a critical component to managing diversity, combating depression and loss of momentum as well as critical items such as coping with stress, making complicated decisions with limited information under compressed time schedules. This is also especially true in times of crisis and will need to be a tool that can be utilized quickly in times of crisis as well as one that can be used over and across time.

The model of the present invention is that one can do a number of functions with the combined approaches that also offers of what Covey has defined as the third alternative. The evaluation of strengths can be done in the context of the personal, professional and public in order to sort abilities into a balanced whole.

For example, on a personal level someone's marriage may be a strong source of stability and inoculates against stress. Another aspect may be one's friendships or family. It is also here that an individual can take stock of their abilities to self-manage, keep fit or whatever other talents relate to the subject at hand. This approach can be done two ways at this point where a person or group can then move down to the Professional strengths and then the Public.

It is equally effective to move to the opportunities or the restrictions. Just for discussion sake we will move to the restrictions first which may entail health considerations, family composition, taking care of other individual, financial concerns or geographical considerations. Once that has been accomplished, an individual is ready to either evaluate their opportunities in this area or they can proceed to the Professional realm saving the brainwork for last. It may be that the consideration is in only one realm or the other, or in some cases of more complexity may require the utilization of all three.

The ability of personally traits, organizational and environmental factors have been studies by researchers interested in entrepreneurship as causes for the success of new endeavors (Baum, 2004). The relationship was surprising because new venture finances and entrepreneurs themselves pointed to their personal characteristics as dominant reasons for success according to Sexton, (2001); Smith & Smith (2000).

A growing group of psychologist based researchers has renewed interest in those characteristics as predictors for success and have moved beyond the past focus on traits to study competencies, motivation, cognition and behaviors. There is a revival occurring of interest in the understanding of the effects of entrepreneurs' personal characteristics (Baum, 2004). For example, Johnson's meta-analysis (1990) found that the need for achievement was the most significant trait predictor of performance in new ventures. In fact many of the restrictions or drawbacks inherent in new venture growth comprise so many of the obstacles for any new challenge they are worth mentioning and include a) extreme uncertainly, b) resource shortage (financing, knowledge, operating assets, and legitimacy), c) surprises, and d) rapid change (Baum, 2004).

To cope with these challenges entrepreneurs must genuinely love their work and be tenacious about pursuing their goals given the many obstacles they would fact. Thus, passion and tenacity seemed the most promising characteristics in terms of leadership as it relates to entrepreneurship for theoretical support, (Locke, 2000; Yukl, 1989). Passion for work or love of one's work has been identified in Locke's (2000) qualitative analyst as a core characteristic of great wealth creators (Baum, 2004).

Entrepreneurs such as Bill Gates and Mary Kay Ask confronted opportunity and challenges with enthusiasm which is so intense that they worked through financial barriers which may be the most observed phenomena of the process. Therefore a strong bent for the identification of opportunities fueled by passion as strength for what one is doing is key to overcoming restrictions in business. Perseverance is a trait that involves sustains goal-directed action and energy even when faced with obstacles and is associated with leadership (Bass & Stogill, 1990, House & Shamir, 1993; Locke, 2000). Baum (2004) introduces new resource skill as the ability to acquire and systematize the operating resources needed to start and grow an organization.

Triangulation, analysis and recycling work together to get to assist in problem solving. Triangulation directs depolarization. This step first looks at containment into manageable cells of information to consider. Next, neutralization breaks out the information into specific contingency for evaluation. Then, the information is summarized to reconstruct it into a condensed form.

Analysis examines variable for new outcomes. The initial phase of analysis involves systematic griding, which sorts and organizes variables in the data field. Then data is then manipulated by systematically rearranging opportunities. Finally, the data is reviewed for common themes to obtain an enhanced perspective.

Recycling involves takeaway redefinition. The initial phase of recycling involves composting, a combining process that increases understanding. Next, the data is sequenced using linear interpretive insight for time line extrapolation. The data is then linked to connect diverse concepts through data recycling.

Tri-Paradigm is a multi-layer triangulate that incorporates the principles, paradigms and models to follow in this outline. The conceptual framework is distributed throughout ×3.

Interpretive Leader is often associated with a consulting practice on hybrid style The philosophy is an individual definition that is a “shared” approach based on integrity. This phase is people, task and situationally oriented (×3) and evaluates whether the leader is born, made or developed. It attempts to elevate the leader from effective to great and then to incredible. Identification and creative sector equals a way of being and includes (1) CMM-degrees of knowing (themes); (2) ROI-spheres of influence (characteristics) and (3) PPP-reasons for being (categorical realms). Tools associated with this aspect include Depolarization, IEQ, Style Integration, FFF, Power Chip, and Responses Spectrum.

The Interpretive Leadership Paradigm generally encompasses the following: (1) Sequential Depolarization Process. ID 3, list 3 more, condenses to one concept; (2) IEQ-Intuitive Extrasensory Quotient-Between double poles of reality and person; (3) Refers to the soul-being and the instinctual knowing everyone possess. I-deification flow process by which the universal energy is tapped into the creative process. (Thinkers, Movers, Feelers, Doers, Sensors); (4) Style integration: refers to the training regarding relationships between the taxonomy, the origination, the styles, levels, characteristics and spheres; and (5) Fame-recognition, fortune-security and fun-recreation: sorting priorities utilizing and creating channel corridors for anger, angst, anxiety, action and avoidance.

Transcendental analysis is an integrative institute for universal formula. The philosophy of this phase is identification, application, and realization. This phase is characterized by the algorithm (3×3×3)3, which means three concepts, three methods, three applications, and three times. Terms associated with this phase are charismatic, transactional, and transformational. The sorting function and factor analysis equal people, task, and situation. Also included in this phase are application and evolution sector, which equals a way of thinking that includes (1) Balance model-interchangeable takeaway, (2) Search model-thematic-griding and (3) Linkage model-interpretive recycling where the recycling encompasses (a) Identification-triangulate (assemble), (b) Apply-square (solve) and (c) Realize-circle (re-configure). Tools associated with this phase include SOR, XYZ, Venn Diagram, Tri-jective, Principle-linkage, MVE, and MHS Construct.

The Transcendental Analysis Paradigm generally encompasses the following: (1) SOR Decision-Multi-dimensional decision making process; (2) Solving XYZ, (horizontally, vertically, central apex and for each quadrant); (3) Venn Diagram composites two diverse concepts and provides apex; (4) Tri-jective: Evaluations based on subjective, objective and collective criteria; (5) Rings-used to illustrate linear sequencing provides additional vesicas; (6) Morals, Values and Ethics-Being Incredible in all identified realms; and (7) Principal Linkage-essence strand aligned vertically with the self.

Quasitative Research looks at universal concepts to combined methodology. The philosophy of this phase is concerned with what is not readily apparent or invisible. The science of what is not or what's missing when evaluating data from partial information-includes a trilogy of applications within each type of research. This phase incorporates qualitative and quantitative approaches as well as mixed designs.

This phase involves creating opportunities by seeing what is not evident. Realization and manifestation equals the way of doing that includes qualitative-concepts/text and quantitative-descriptive/numbers. Mixed Design-signs/symbols associated with this phase are operational, experimental and instrumental. Operational includes process and manipulation. Experimental tests frequencies and distribution. Instrumental assigns values/instrumentation. The values include (1) assets-positive/ought (+), (2) liabilities-negative/naught (−), and (3) opportunities-neutralities/dot (=).Tools associated with this phase includes Interpretive Recycling, Reconfiguration, FSR, WNS, IEE, and UUU.

The Quasitative Research Paradigm generally encompasses the following: (1) Ultimate Takeaways from Venn Diagram composite; (2) LDRS: leadership developmental rating scale-interpretations at every step; (3) Universal application through WNS (words, numbers, symbols/signs); (4) Basic Skill Set workbook-creation, evolution, manifestation process; (5) IEE-Internal, external and ongoing sequencing (6) Reconfiguration-Practice, Drill and Rehearse; (7) FSR-Factoring, sorting and recombining-linkage rings; (8) Ultimate Universal Understandings-Integrated Understanding

The method of the present invention is suited for use in conjunction with one or more of the following educational techniques (1) Power Chips; (2) books, (3) Tri-Data dictionary; (4) research articles; (5) decks of cards; (6) online sessions, (7) audio tapes; (8) CD-Meta-triangulation; (9) video games; and (10) geometric confetti.

The method of the present invention has applicability in a variety of areas including (1) Clinical Assessment; (2) Corporate Consulting; (3) Executive Coaching; (4) Project Management; (5) Image Branding; (6) Planning Seminars; (7) Ergo-metrics; (8) Personal Training; (9) Leadership Development; (10) Graphic Design; (11) Program Workshops; and (12) Statistical Analysis.

Paradigm shifts associated with the method of the present invention include: (1) Bi-lateral thinking to better handle adversity; (2) Quasi-research (triangulation of three methods); (3) Both hemispheres right-creativity, left-logic combined=intuition; (4) Soul is WILL not spirit and part of a visceral/instinctive response system; (5) IEQ (intuitive extrasensory quotient) is the culmination of intelligence and emotional competency quotients; (6) The heart IS considered a logical/emotional functioning area; (7) Triangulate between the poles of Spirituality and Physical reality; (8) Business is combined with Education and Psychology; (9) Leadership is related to every discipline; (10) Flow is the connection occurring when nature, number and nurture combine; (11) True balance: Multi-sensory functioning on all five planes; (12) Quotient Psychology (sum of integrity, reliable difference and product validity); (13) Nuclear formula: Concept×Context×Connect/Construct; (14) Social Science Algebra; Cipher combined with algorithm; (15) SOR Analysis (emphasis on “O” for opportunities); (16) R's-reading a situation, righting your attitude, research options, being cognizant of rhythm or timing of your actions and obtaining the realization of potential; and (17) Instead of squaring the circle resulting in the octagon the triangle represents the empirical reality between the temporal and corporeal realms.

It is contemplated that features disclosed in this application, as well as those described in the above applications incorporated by reference, can be mixed and matched to suit particular circumstances. Various other modifications and changes will be apparent to those of ordinary skill.

1. A psychological development system comprising triangulation, categorization and interpretation.

2. A psychological development system comprising evaluating at least three things in at least three ways in at least three levels that is repeated at least three times.
